(19) United States
(12) Patent Application Publication
(10) Pub. No.: US 2018/0294673 A1
(43) Pub. Date: Oct. 11, 2018

(54) WIRELESS POWER TRANSMITTER

(71) Applicant: LG INNOTEK CO., LTD., Seoul (KR)

(72) Inventor: Su Ho BAE, Seoul (KR)

(73) Assignee: LG INNOTEK CO., LTD., Seoul (KR)

(21) Appl. No.: 15/766,311

(22) PCT Filed: Oct. 12, 2016
(86) PCT No.: PCT/KR2016/011405

§ 371 Date: Apr. 5, 2018

(30) Foreign Application Priority Data
Nov. 2, 2015 (KR) 10-2015-0153231

(51) Int. Cl. H02J 50/12; H02J 7/02; H02J 50/90

(52) U.S. Cl. CPC H02J 50/12; H02J 50/90; H02J 7/025

(57) ABSTRACT

The present invention relates to a wireless power transmission technique and, more specifically, to a wireless power transmitter capable of improving the efficiency of wireless power transmission to improve the performance thereof. A wireless power transmitter according to an embodiment of the present invention comprises: a first transmission coil which includes a first area spaced apart from an interface surface at a first distance, and a second area spaced apart from the interface surface at a second distance; and a second transmission coil which overlaps the second area, wherein the first distance may be less than the second distance.

### TECHNICAL FIELD

Embodiments relate to a wireless power transmission technique, and more particularly, to a wireless power transmitter capable of improving performance by improving the efficiency of wireless power transmission.

### BACKGROUND ART

Recently, as information and communication technology rapidly develops, a ubiquitous society based on information and communication technology is being formed.

To allow information communication devices to be connected anytime and anywhere, sensors equipped with a computer chip having a communication function should be installed in all facilities. Therefore, supply of power to these devices or sensors is a new challenge. In addition, as the kinds of portable devices such as Bluetooth handsets and music players like iPods, as well as mobile phones, rapidly increase in number, charging batteries thereof has required time and effort. As a way to address this issue, wireless power transmission technology has recently drawn attention.

Wireless power transmission (or wireless energy transfer) is a technology for wirelessly transmitting electric energy from a transmitter to a receiver based on the induction principle of a magnetic field. Back in the 1800s, electric motors or transformers based on electromagnetic induction began to be used. Thereafter, a method of transmitting electric energy by radiating an electromagnetic wave, such as a radio wave or laser, was tried. Electric toothbrushes and some wireless shavers popular among people are charged through electromagnetic induction.

Wireless energy transmission techniques introduced up to now may be broadly divided into magnetic induction, electromagnetic resonance, and RE transmission employing a short wavelength radio frequency.

In the magnetic induction scheme, when two coils are arranged adjacent to each other and current is applied to one of the coils, a magnetic flux generated at this time generates electromotive force in the other coil. This technology is being rapidly commercialized mainly for small devices such as mobile phones. In the electromagnetic induction scheme, power of up to several hundred kilowatts (kW) may be transmitted with high efficiency, but the maximum transmission distance is less than or equal to 1 cm. As a result, devices are generally required to be placed adjacent to a charger or a pad, which is disadvantageous.

The magnetic resonance scheme uses an electric field or a magnetic field instead of employing an electromagnetic wave or current. The magnetic resonance scheme is advantageous in that the scheme is safe for other electronic devices or the human body since it is hardly influenced by the electromagnetic waves. However, the distance and space available for this scheme are limited, and the energy transfer efficiency of the scheme is rather low.

The short-wavelength wireless power transmission scheme (simply, RF transmission scheme) takes advantage of the fact that energy can be transmitted and received directly in the form of radio waves. This technique is an RF-based wireless power transmission scheme using a rectenna. A rectenna, which is a compound of antenna and rectifier, refers to a device that converts RF power directly into direct current (DC) power. That is, the RF scheme is a technique of converting AC radio waves into DC waves. Recently, with improvement in efficiency, commercialization of RF technology has been actively researched.

The wireless power transmission technique is employable in various industries including IT, railroads, and home appliance industries as well as the mobile industry.

Recently, wireless power transmitters equipped with a plurality of coils have been introduced to increase the recognition rate of a wireless power receiver placed on a charging bed. The plurality of coils may be formed in a plurality of layers.

In particular, in the case of transmission of wireless power according to the electromagnetic induction scheme, the efficiency of wireless power transmission depends on the distance between the surface on which the wireless power receiver is placed and the coils. That is, the wireless power transmission efficiency of a coil located at a lower position at a longer distance from the wireless power receiver among the plurality of coils becomes relatively low, resulting in performance degradation.

### DISCLOSURE

### Technical Problem

Therefore, the present disclosure has been made in view of the above problems, and embodiments provide a wireless power transmitter.

Embodiments also provide a wireless power transmitter capable of improving the wireless power transmission efficiency of a transmission coil belonging to a lower layer.

The technical objects that can be achieved through the embodiments are not limited to what has been particularly described hereinabove and other technical objects not described herein will be more clearly understood by persons skilled in the art from the following detailed description.

### Technical Solution

In one embodiment, a wireless power transmitter includes a first transmission coil comprising a first region spaced a first distance from an interface surface and a second region spaced a second distance from the interface surface, and a second transmission coil overlapping the second region, wherein the first distance may be less than the second distance.

According to an embodiment, the first transmission coil may have a shape bent toward the interface surface.

According to an embodiment, an average distance between the first transmission coil and the interface surface may decrease as a ratio of a horizontal length of the first region to a total horizontal length of the first transmission coil increases.

According to an embodiment, an average distance between the first transmission coil and the interface surface may decrease as a ratio of an area of the first region to a total area of the first transmission coil increases.

According to an embodiment, a difference between the first distance and the second distance may be a thickness of the first transmission coil.

According to an embodiment, the wireless power transmitter may further include a third transmission coil having a structure symmetrical to the first transmission coil.

In another embodiment, a wireless power transmitter includes a first transmission coil comprising a first region spaced a first distance from an interface surface and a second region spaced a second distance from the interface surface, and a second transmission coil overlapping the first region in a horizontal direction, wherein the first distance may be less than the second distance.

The above-described aspects of the present disclosure are merely a part of preferred embodiments of the present disclosure. Those skilled in the art will derive and understand various embodiments reflecting the technical features of the present disclosure from the following detailed description of the present disclosure.

### Advantageous Effects

The apparatus according to the embodiments has the following effects.

In a wireless power transmitter according to an embodiment, a coil located at a lower position among overlapping coils may be implemented in a curved shape to reduce an average distance between the coil and an interface surface. Thereby, wireless power transmission efficiency may be improved.

In addition, in a wireless power transmitter according to an embodiment, a coil located at a lower position among overlapping coils may be implemented in a curved shape to reduce an average distance between the coil and an interface surface. Thereby, power consumption for sensing signal transmission may be reduced and power transmission efficiency may be enhanced.

It will be appreciated by those skilled in the art that that the effects that can be achieved through the embodiments of the present disclosure are not limited to those described above and other advantages of the present disclosure will be more clearly understood from the following detailed description.

### DESCRIPTION OF DRAWINGS

The accompanying drawings, which are included to provide a further understanding of the disclosure, illustrate embodiments of the disclosure. It is to be understood, however, that the technical features of the present disclosure are not limited to specific drawings, and the features disclosed in the drawings may be combined with each other to constitute a new embodiment.

FIG. 1 is a diagram illustrating a sensing signal transmission procedure in a wireless power transmitter according to an embodiment of the present disclosure.

FIG. 2 is a state transition diagram illustrating a wireless power transmission procedure defined in the WPC standard.

FIG. 3 is a state transition diagram illustrating a wireless power transmission procedure defined in the PMA standard.

FIG. 4 is a diagram illustrating a wireless charging system employing the electromagnetic induction scheme according to an embodiment of the present disclosure.

FIG. 5 is a diagram illustrating a transmission coil according to an embodiment of the present disclosure.

FIG. 6 is a diagram illustrating a method of manufacturing a transmission coil layer according to an embodiment of the present disclosure.

FIG. 7 is a front view of the transmission coil layers shown in FIG. 6.

### BEST MODE

A wireless power transmitter according to a first embodiment of the present disclosure may include a first transmission coil including a first region spaced apart from an interface surface by a first distance and a second region spaced from the interface surface by a second distance, and a second transmission coil overlapping the second region, wherein the first distance may be shorter than the second distance.

### [Mode for Invention]

Hereinafter, an apparatus and various methods to which embodiments of the present disclosure are applied will be described in detail with reference to the drawings. As used herein, the suffixes “module” and “unit” are added or used interchangeably to facilitate preparation of this specification and are not intended to suggest distinct meanings or functions.

In the description of the embodiments, it is to be understood that, when an element is described as being “on”/“over” or “beneath”/“under” another element, the two elements may directly contact each other or may be arranged with one or more intervening elements present therebetween. Also, the terms “on”/“over” or “beneath”/“under” may refer to not only an upward direction but also a downward direction with respect to one element.

For simplicity, in the description of the embodiments, “wireless power transmitter,” “wireless power transmission apparatus,” “transmission terminal,” “transmitter,” “transmission apparatus,” “transmission side,” “wireless power transfer apparatus,” “wireless power transferer,” and the like will be interchangeably used to refer to an apparatus for transmitting wireless power in a wireless power system. In addition, “wireless power reception apparatus,” “wireless power receiver,” “reception terminal,” “reception side,” “reception apparatus,” “receiver,” and the like will be used interchangeably to refer to an apparatus for receiving wireless power from a wireless power transmission apparatus.

The transmitter according to the present disclosure may be configured as a pad type, a cradle type, an access point (AP) type, a small base station type, a stand type, a ceiling embedded type, a wall-mounted type, or the like. One transmitter may transmit power to a plurality of wireless power reception apparatuses. To this end, the transmitter may include at least one wireless power transmission means. Here, the wireless power transmission means may employ various wireless power transmission standards which are based on the electromagnetic induction scheme for charging according to the electromagnetic induction principle meaning that a magnetic field is generated in a power transmission terminal coil and current is induced in a reception terminal coil by the magnetic field. Here, the wireless power transmission mains may include wireless charging technology using the electromagnetic induction schemes defined by the Wireless Power Consortium (WPC) and the Power Matters Alliance (PMA), which are wireless charging technology standard organizations.

In addition, a receiver according to an embodiment of the present disclosure may include at least one wireless power reception means, and may receive wireless power from two or more transmitters simultaneously. Here, the wireless power reception means may include wireless charging technologies of electromagnetic induction schemes defined by the Wireless Power Consortium (WPC) and the Power Matters Alliance (PMA), which are wireless charging technology standard organizations.

The receiver according to the present disclosure may be employed in small electronic devices including a mobile phone, a smartphone, a laptop computer, a digital broadcasting terminal, a PDA (Personal Digital Assistant), a PMP (Portable Multimedia Player), a navigation device, an electric toothbrush, an electronic tag, a lighting device, a remote control, a fishing float, and wearable devices such as a smart watch. However, the embodiments are not limited thereto. The applications may include any devices which are equipped with a wireless power transmission means and have a rechargeable battery.

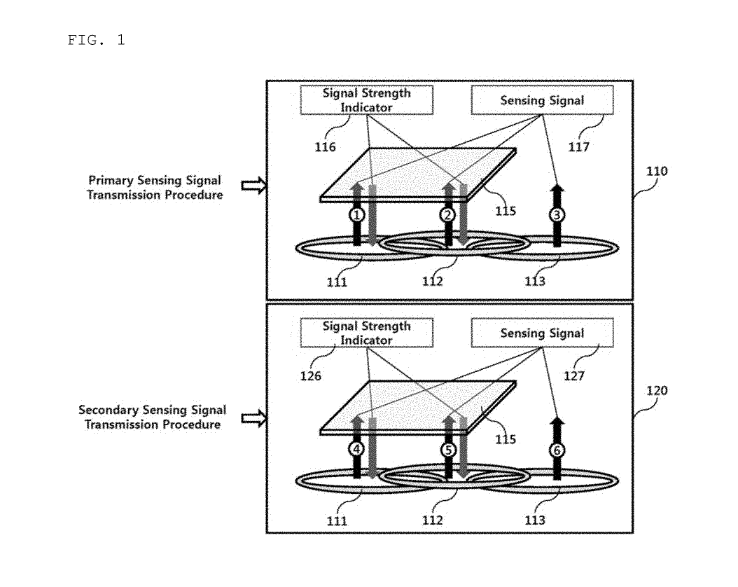

FIG. 1 is a diagram illustrating a sensing signal transmission procedure in a wireless power transmitter according to an embodiment of the present disclosure.

Referring to FIG. 1, the wireless power transmitter may be equipped with three transmission coils 111, 112, and 113. Each transmission coil may have a region partially overlapping the other transmission coils, and the wireless power transmitter sequentially transmits predetermined sensing signals 117, 127 for sensing presence of a wireless power receiver through the respective transmission coils, for example, digital ping signals, in a predefined order.

As shown in FIG. 1, the wireless power transmitter may sequentially transmit sensing signals 117 through a primary sensing signal transmission procedure, which is indicated by reference numeral 110, and identify transmission coils 111 and 112 receiving a signal intensity indicator 116 from the wireless power receiver 115. Subsequently, the wireless power transmitter may sequentially transmit sensing signals 127 through a secondary sensing signal transmission procedure, which is indicated by reference numeral 120, identify a transmission coil exhibiting a better power transmission efficiency (or charging efficiency), namely a better alignment between the transmission coil and the reception coil, between the transmission coils 111 and 112 receiving the signal strength indicator 126, and perform a control operation to transmit power through the identified transmission coil, that is, to perform wireless charging.

Causing the wireless power transmitter to perform two sensing signal transmission procedures as shown in FIG. 1 is intended to more accurately identify a transmission coil that is better aligned with the reception coil of the wireless power receiver.

If the signal strength indicators 116 and 126 are received by the first transmission coil 111 and the second transmission coil 112 as indicated by reference numerals 110 and 120 of FIG. 1, the wireless power transmitter selects a transmission coil exhibiting the best alignment based on the signal strength indicator 126 received by each of the first transmission coil 111 and the second transmission coil 112 and performs wireless charging using the selected transmission coil.

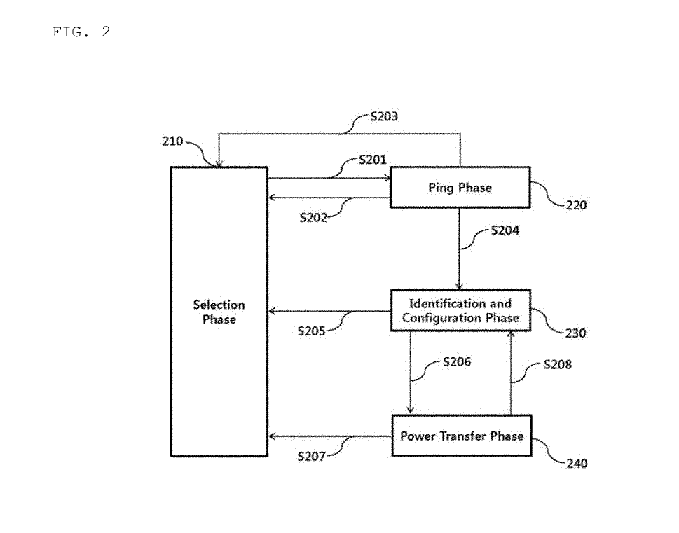

FIG. 2 is a state transition diagram illustrating a wireless power transmission procedure defined in the WPC standard.

Referring to FIG. 2, power transmission from a transmitter to a receiver according to the WPC standard is broadly divided into a selection phase 210, a ping phase 220, an identification and configuration phase 230, and a power transfer phase 240.

The selection phase 210 may be a phase in which transition occurs when a specific error or a specific event is sensed while power transmission begins or is maintained. Here, the specific error and the specific event will be clarified through the following description. Further, in the selection phase 210, the transmitter may monitor whether an object is present at the interface surface. When the transmitter senses an object being placed on the interface surface, may transition to the ping phase 220 (S201). In the selection phase 210, the transmitter may transmit an analog ping signal of a very short pulse and sense whether there is an object in the active area of the interface surface based on the change in current of the transmission coils.

When the transmitter senses an object in the ping phase 220, it activates the receiver and transmits a digital ping to identify whether the receiver is a WPC standard-compatible receiver. If the transmitter does not receive a response signal (e.g., a signal strength indicator) for the digital ping from the receiver in the ping phase 220, it may transition back to the selection phase 210 (S202). In addition, if the transmitter receives, from the receiver, a signal indicating completion of power transmission, that is, a charge completion signal, the transmitter may transition to the selection phase 210 (S203).

Once the ping phase 220 is complete, the transmitter may transition to the identification and configuration phase 230 for identifying the receiver and collecting configuration and state information about the receiver (S204).

In the identification and configuration phase 230, the transmitter may transition to the selection phase 210 if an unexpected packet is received (unexpected packet), a desired packet is not received for a predefined time (timeout), there is an error in packet transmission (transmission error) or no power transfer contract is made (no power transfer contract) (S205).

Once identification and configuration of the receiver are complete, the transmitter may transition to the power transfer phase 240, wherein wireless power is transmitted (S206).

In the power transfer phase 240, the transmitter may transition to the selection phase 210 if an unexpected packet is received (unexpected packet), a desired packet is not received for a predefined time (timeout), a violation of a pre-established power transmission contract occurs (power transfer contract violation), and the charging is complete (S207).

In addition, in the power transfer phase 240, if the power transfer contract needs to be reconfigured according to change in the state of the transmitter, the transmitter may transition to the identification and configuration phase 230 (S208).

The above-mentioned power transmission contract may be set based on the state and characteristics information about the transmitter and the receiver. For example, the transmitter state information may include information on a maximum amount of transmittable power and information on a maximum number of acceptable receivers, and the receiver state information may include information on the required power.

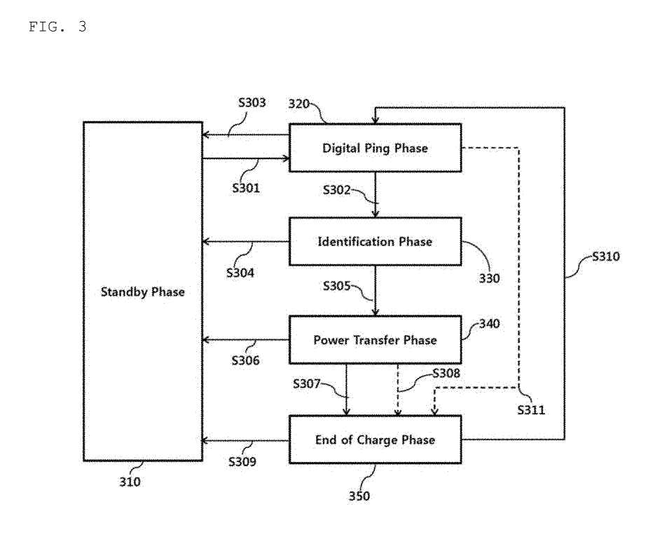

FIG. 3 is a state transition diagram illustrating a wireless power transmission procedure defined in the PMA standard.

Referring to FIG. 3, power transmission from a transmitter to a receiver according to the PMA standard is broadly divided into a Standby phase 310, a Digital Ping phase 320, an Identification phase 330, a Power Transfer phase 340, and an End of Charge phase 350.

The Standby phase 310 may be a phase for performing transition when a specific error or a specific event is sensed while a receiver identification procedure for power transmission is performed or power transmission is maintained. Here, the specific error and the specific event will be clarified through the following description. In addition, in the Standby phase 310, the transmitter may monitor whether an object is present on a charging surface. When the transmitter senses an object being placed on the charging surface or an RXID retry is in progress, it may transition to the Digital Ping phase 320 (S301). Here, RXID is a unique identifier assigned to a PMA-compatible receiver. In the Standby phase 310, the transmitter may transmit an analog ping very short pulse, and sense, based on the change in current of the transmission coil, whether there is an object in the active area of the interface surface, for example, the charging bed.

Upon transitioning to the Digital Ping phase 320, the transmitter sends a digital ping signal to identify whether the sensed object is a PMA-compatible receiver. When sufficient power is supplied to the reception terminal by the digital ping signal transmitted by the transmitter, the receiver may modulate the received digital ping signal according to the PMA communication protocol and transmit a predetermined response signal to the transmitter. Here, the response signal may include a signal strength indicator indicating the strength of the power received by the receiver. When a valid response signal is received in the Digital Ping phase 320, the receiver may transition to the Identification phase 330 (S302).

If the response signal is not received or it is determined that the receiver is not a PMA-compatible receiver (i.e., Foreign Object Detection (FOD)) in the Digital Ping phase 320, the transmitter may transition to the Standby phase 310 (S303). As an example, a foreign object (FO) may be a metallic object including a coin and a key.

In the Identification phase 330, the transmitter may transition to the Standby phase 310 if the receiver identification procedure fails or needs to be re-performed and if the receiver identification procedure is not completed for a predefined time (S304).

If the transmitter succeeds in identifying the receiver, the transmitter may transition from the Identification phase 330 to the Power Transfer phase 340 and initiate charging (S305).

In the Power Transfer phase 340, the transmitter may transition to the Standby phase 310 if a desired signal is not received within a predetermined time (timeout), a foreign object (FO) is sensed, or the voltage of the transmission coil exceeds a predefined reference value (S306).

In addition, in the Power Transfer phase 340, the transmitter may transition to the End of Charge phase 350 if the temperature sensed by a temperature sensor provided in the transmitter exceeds a predetermined reference value (S307).

In the End of Charge phase 350, if the transmitter determines that the receiver has been removed from the charging surface, the transmitter may transition to the Standby state 310 (S309).

In addition, if a temperature measured in the over-temperature state after lapse of a predetermined time drops below a reference value, the transmitter may transition from the End of Charge phase 350 to the Digital Ping phase 320 (S310).

In the Digital Ping phase 320 or the Power Transfer phase 340, the transmitter may transition to the End of Charge phase 350 when an End of Charge (EOC) request is received from the receiver (S308 and S311).

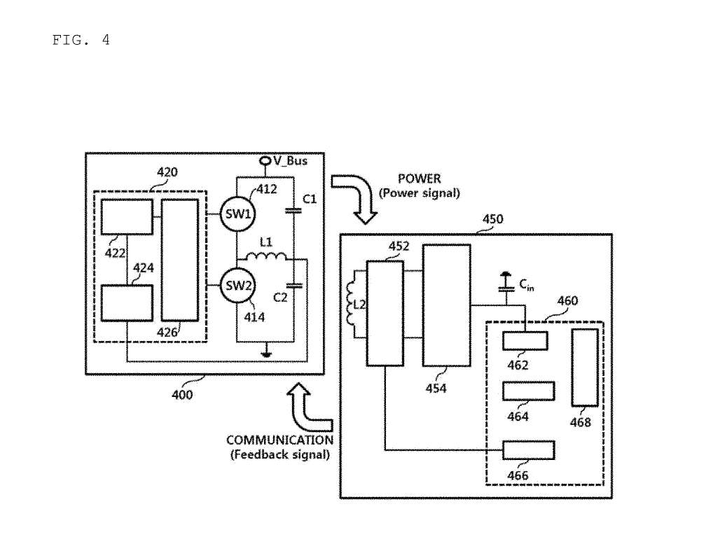

FIG. 4 is a diagram illustrating a wireless charging system employing the electromagnetic induction scheme according to an embodiment of the present disclosure.

Referring to FIG. 4, a wireless charging system employing the electromagnetic induction scheme includes a wireless power transmitter 400 and a wireless power receiver 450. The wireless power transmitter 400 and the wireless power receiver 450 are substantially identical to the wireless power transmitter and wireless power receiver described with reference to FIG. 1.

Positioning electronic devices including the wireless power receiver 450 on the wireless power transmitter 400 may cause the coils of the wireless power transmitter 400 and the wireless power receiver 450 to be coupled with each other by an electromagnetic field.

To create an electromagnetic field for power transmission, the wireless power transmitter 400 may modulate a power signal and change the frequency thereof. The wireless power receiver 450 may receive power by demodulating the electromagnetic signal conforming to a protocol set to fit a wireless communication environment and transmit a feedback signal to the wireless power transmitter 400 via in-band communication, wherein the feedback signal is intended for control of the intensity of transmit power of the wireless power transmitter 400 based on the intensity of the received power. For example, the wireless power transmitter 400 may control the operational frequency according to a control signal for power control to increase or decrease the transmit power.

The amount (or increase/decrease) of transmitted power may be controlled using the feedback signal transmitted from the wireless power receiver 450 to the wireless power transmitter 400. Communication between the wireless power receiver 450 and the wireless power transmitter 400 is not limited to in-band communication using the feedback signal described above, and may be performed using out-of-band communication including a separate communication module. For example, a short-range wireless communication module such as a Bluetooth module, a Bluetooth Low Energy (BLE) module, an NFC module, or a ZigBee module may be used.

In the electromagnetic induction scheme, a frequency modulation scheme may be used as a protocol for exchanging state information and control signals between the wireless power transmitter 400 and the wireless power receiver 450. Through the protocol, device identification information, charging state information, power control signals, and the like may be exchanged.

As shown in FIG. 4, the wireless power transmitter 400 according to an embodiment of the present disclosure includes a signal generator 420 for generating a power signal, a coil L1 and capacitors Cl and C2 positioned between power supply terminals V Bus and GND capable of sensing a feedback signal transmitted from the wireless power receiver 450, and switches SW1 and SW2 whose operation is controlled by the signal generator 420. The signal generator 420 may include a demodulator 424 for demodulating a feedback signal transmitted through the coil L1, a frequency driver 426 for changing the frequency thereof, and a transmission controller 422 for controlling the modulator 424 and the frequency driver 426. The feedback signal transmitted through the coil L1 may be demodulated by the demodulator 424 and then input to the transmission controller 422. The transmission controller 422 may control the frequency driver 426 based on the demodulated signal to change the frequency of the power signal transmitted through the coil L1.

The wireless power receiver 450 may include a modulator 452 for transmitting a feedback signal through a coil L2, a rectifier 454 for converting an AC signal received through the coil L2 into a DC signal, and a reception controller 460 for controlling the modulator 452 and the rectifier 454. The reception controller 460 may include a power supply 462 for supplying power necessary for operation of the rectifier 454 and the wireless power receiver 450, and a DC-DC converter 464 for changing the DC output voltage of the rectifier 454 to a DC voltage satisfying the charging requirements of a charging target (a load 468), a load 468 to which the converted power is output, and a feedback communication unit 466 for generating a feedback signal for providing a receive power state and a state of the charging target to the wireless power transmitter 400.

In FIG. 4, the coil L1 included in the wireless power transmitter 400 may refer to the three transmission coils 111, 112 and 113 shown in FIG. 1, and a switch SW1, SW2 and a capacitor C1, C2 which are connected to the transmission coils 111, 112 and 113 may be independently provided for each of the transmission coils 111, 112 and 113. However, embodiments of the present disclosure are not limited thereto.

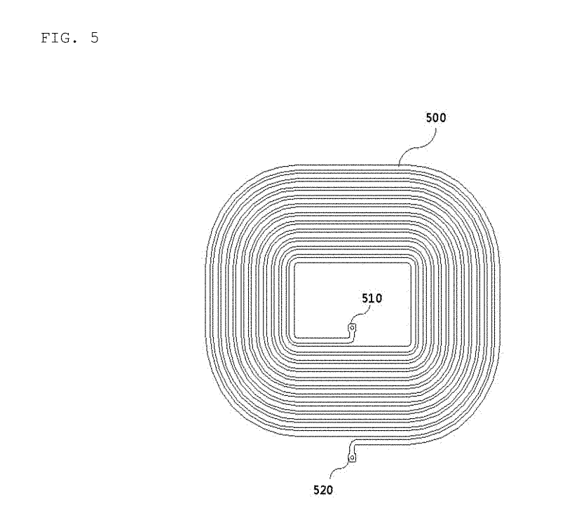

FIG. 5 is a diagram illustrating a transmission coil according to an embodiment of the present disclosure.

Referring to FIG. 5, the transmission coil 500 may be implemented in a manner that a wire configured with a conductor having a high conductivity (e.g., copper (Cu)) positioned at the center and an insulating coating (e.g., fiber, a plastic material) surrounding the same is wound in concentric circles.

While the transmission coil 500 is illustrated in FIG. 5 as forming a concentric quadrangular structure, embodiments of the present disclosure are not limited thereto. The transmission coil may be embodied in various structures such as a concentric spiral structure or a concentric octagonal structure.

A first terminal 510 may be formed at the inner end of the transmission coil 500 and a second terminal 520 may be formed at the outer end of the transmission coil 500. The first terminal 510 and the second terminal 520 correspond to both ends of the coil L1 shown in FIG. 4 and may be connected to a control circuit board. The control circuit board corresponds to a substrate including the switches SW1 and SW2 and elements for controlling the operation of the wireless power transmitter 400 such as the signal generator 420.

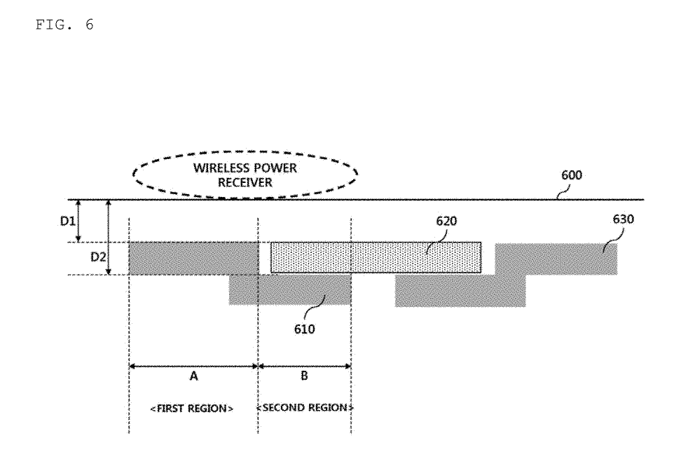

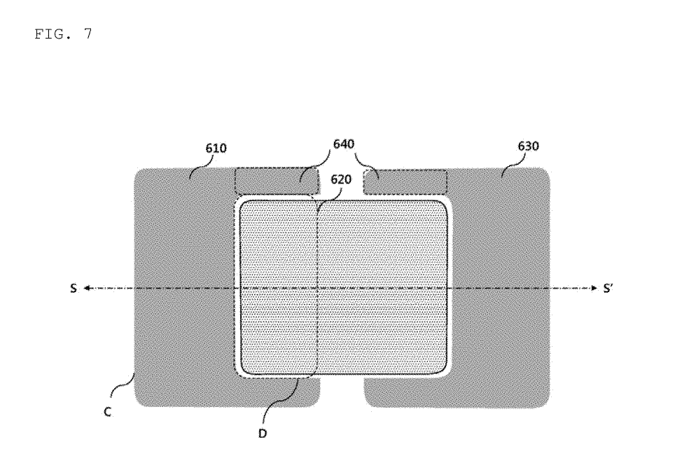

FIG. 6 is a diagram illustrating a method of manufacturing a transmission coil layer according to an embodiment of the present disclosure. FIG. 7 is a front view of the transmission coil layer shown in FIG. 6.

Referring to FIGS. 6 and 7, the transmission coil layer may include first to third coils 610, 620 and 630.

Each of the first to third transmission coils 610, 620 and 630 may be implemented using the transmission coil 500 shown in FIG. 5, and the regions thereof allowing wireless charging may be arranged completely separated from each other in an overlapping manner such that any dead spot, which is a region where charging is not possible, is not produced therein. Thus, the first to third transmission coils 610, 620 and 630 form at least two layers.

Since the conductors of the first to third transmission coils 610, 620, and 630 are respectively insulated by an insulation coating, the first through third transmission coils 610, 620, and 630 may be disposed in close contact with each other.

The first transmission coil 610 and the third transmission coil 630 may be symmetrically disposed with respect to the second transmission coil 620, and the second transmission coil 620 may be disposed at a certain distance over the interface surface 600, which is an outer boundary surface of the wireless power transmitter where the wireless power receiver may be placed. In the space as wide as the certain distance, a case or the like configured to define the appearance of the wireless power transmitter and protect the internal elements may be arranged.

Since the third transmission coil 630 has a symmetrical structure substantially identical to the first transmission coil 610, only the structure of the first transmission coil 610 will be described in detail with reference to FIG. 6.

The first transmission coil 610 may include a first region and a second region, wherein the first region is a region whose distance (shortest distance) from the interface surface 600 is a first distance D1, and the second region is a region whose distance (shortest distance) from the interface surface 600 is a second distance D2. Although the difference between the second distance D2 and the first distance D1 is shown as being the thickness of the first transmission coil 610 in FIG. 6, embodiments of the present disclosure are not limited thereto.

For this structure, the first transmission coil 610 may have a shape bent toward the interface surface 600. While it is illustrated in FIG. 6 that the corner of the bent portion is assumed to be bent at the right angle, the corner may be smoothly curved.

Accordingly, at least a part of the first region may overlap the second transmission coil 620 in the horizontal direction, and at least a part of the second region may overlap the second transmission coil 620 in the vertical direction.

Assuming that the entire region of the first transmission coil 610 has a straight shape such that the distance from the interface surface 600 is the second distance D2 in contrast with the case of FIG. 6 (comparative example), the average distance between the first transmission coil 610 and interface surface 600 is the second distance D2.

On the other hand, when the first transmission coil 610 includes the first region and the second region according to the embodiment of the present disclosure shown in FIG. 6, the average distance D_AVR between the first transmission coil 610 and the interface surface 600 may be calculated by Equation 1 given below.

$$D\_AVR = \frac{A \times D 1 + B \times D 2}{A + B} . \qquad Equation 1$$

Here, A denotes the horizontal length of the first region and B denotes the horizontal length of the second region.

Accordingly, the distance D_DCR between the first transmission coil 610 and the interface surface 600, which is reduced compared to the comparative example, may be calculated by Equation 2 given below.

$$D\_DCR = D 2 - D\_AVR = \frac{A}{A + B} ( D 2 - D 1 ) . \qquad Equation 2$$

Therefore, as the ratio of the horizontal length (A) of the first region to the total horizontal length (A+B) of the first transmission coil 610 increases, the average distance D_AVR between the first transmission coil 610 and the interface surface 600 may be reduced.

In the wireless charging system of the electromagnetic induction scheme, matching between a transmission coil and a receiving coil has a great influence on wireless power transmission efficiency, which increases as the distance between the transmission coil and the receiving coil decreases.

Suppose that the first distance D1 is 2 mm and the second distance is 3.5 mm. In this case, in the comparative example, the average distance between the first transmission coil 610 and the interface surface 600 may be 3.5 mm and the wireless power transmission efficiency may be 59%. In addition, the average distance between the second transmission coil 620 and the interface surface 600 may be 2 mm and the wireless power transmission efficiency may be 62%.

In contrast, the average distance between the first transmission coil 610 and the interface surface 600 according to an embodiment of the present disclosure is 2.75 mm in Equation 1, and the reduced distance is 0.75 mm in Equation 2.

As a result, according to an embodiment of the present disclosure, the distance between the first transmission coil 610 and the interface surface 600 may be reduced by 0.75 mm due to the bent shape, and the wireless power transmission efficiency may be improved from 59% to 60.7%.

Likewise, the wireless power transmission efficiency in the third transmission coil 630, which has substantially the same structure as the first transmission coil 610 may be improved.

In a wireless power transmitter including a plurality of transmission coils arranged in at least two layers in order to prevent a dead spot from being created, the wireless power transmission efficiency of a transmission coil belonging to a lower layer may be relatively lowered.

However, in the case of the wireless power transmitter according to an embodiment of the present disclosure, a coil arranged at a lower position among the overlapping coils may be implemented in a bent shape to reduce the average distance to the interface surface. Thereby, the wireless power transmission efficiency may be improved.

In the standby mode, each of the transmission coils 610, 620, and 630 transmits the sensing signals 117 and 127 illustrated in FIG. 1. In this regard, the same reception sensitivity of the sensing signals 177 and 127 should be implemented with respect to the interface surface 600. Signals are attenuated as the transmission distance increases. Accordingly, the voltage applied to the transmission coils 610 and 630 at a lower position must be higher than the voltage applied to the transmission coil 620 at an upper position.

However, in the wireless power transmitter according to an embodiment of the present disclosure, the coil arranged at the lower portion is implemented in a bent shape to reduce the average distance between the coil and the interface surface. Thereby, power consumption required for transmission of a sensing signal may be reduced, and the power transmission efficiency may be enhanced.

FIG. 7 shows a front view of the transmission coil layers viewed from the interface surface 600.

The second transmission coil 620 and the first and third transmission coils 610 and 630 may be arranged overlapping each other so as not to create dead spots.

The view of the transmission coil layers shown in FIG. 6 corresponds to a cross section taken along line S-S′ in FIG. 7.

In FIG. 7, it is illustrated that each of the transmission coils 610, 620, and 630 is implemented in a rectangular shape having a width and a length which are not equal to each other. In this case, a region 640 which is positioned on the same line as the second region of FIG. 6 and does not overlap the second transmission coil 620 is formed. However, since it does not overlap the second transmission coil 620, it may be implemented in a bent shape to have a distance to the interface surface 600 which is the first distance D1, as in the case of the first region.

That is, the regions of the first and third transmission coils 610 and 630 other than the part thereof overlapping the second transmission coil 620 arranged thereon may be implemented in a bent shape to have a distance to the interface surface 600 equal to the first distance D1. Embodiments of the present disclosure are not limited to the shape and arrangement of the transmission coils 610, 620 and 630 of FIG. 7, and this structure may be employed irrespective of the shape and arrangement described above.

Thus, the average distance D_AVR′ between the entirety of the first transmission coil 610 and the interface surface 600 may be calculated by Equation 3 given below.

$${D\_AVR}^{′} = \frac{C \times D 1 + D \times D 2}{C + D} . \qquad Equation 3$$

Here, C denotes the area of the first region and D denotes the area of the second region.

Accordingly, the distance D_DCR′ between the first transmission coil 610 according to an embodiment of the present disclosure and the interface surface 600 shrunk compared to the comparative example described with reference to FIG. 6 may be calculated by Equation 4 given below.

$${D\_DCR}^{′} = D 2 - {D\_AVR}^{′} = \frac{C}{C + D} ( D 2 - D 1 ) . \qquad Equation 4$$

Therefore, as the ratio of the area (C) of the first region to the total area (C+D) of the first transmission coil 610 increases, the average distance D_AVR′ between the first transmission coil 610 and the interface surface 600 may be reduced.

That is, in the case of the wireless power transmitter according to an embodiment of the present disclosure, a coil arranged at a lower position among the overlapping coils may be implemented in a bent shape to reduce the average distance to the interface surface. Thereby, wireless power transmission efficiency may be improved.

The method according to embodiments of the present disclosure may be implemented as a program to be executed on a computer and stored in a computer-readable recording medium. Examples of the computer-readable recording medium include ROM, RAM, CD-ROM, magnetic tapes, floppy disks, and optical data storage devices, and also include carrier-wave type implementation (e.g., transmission over the Internet).

The computer-readable recording medium may be distributed to a computer system connected over a network, and computer-readable code may be stored and executed thereon in a distributed manner. Functional programs, code, and code segments for implementing the method described above may be easily inferred by programmers in the art to which the embodiments pertain.

It is apparent to those skilled in the art that the present disclosure may be embodied in specific forms other than those set forth herein without departing from the spirit and essential characteristics of the present disclosure.

Therefore, the above embodiments should be construed in all aspects as illustrative and not restrictive. The scope of the disclosure should be determined by the appended claims and their legal equivalents, and all changes coming within the meaning and equivalency range of the appended claims are intended to be embraced therein.

### INDUSTRIAL APPLICABILITY

The present disclosure relates to wireless charging technology and is applicable to a wireless power transmission apparatus that wirelessly transmits power.

1. A wireless power transmitter comprising:
a first transmission coil comprising a first region spaced a first distance from an interface surface and a second region spaced a second distance from the interface surface; and
a second transmission coil overlapping the second region,
wherein the first distance is less than the second distance.

2. The wireless power transmitter according to claim 1, wherein the first transmission coil has a shape bent toward the interface surface.

3. The wireless power transmitter according to claim 1, wherein an average distance between the first transmission coil and the interface surface decreases as a ratio of a horizontal length of the first region to a total horizontal length of the first transmission coil increases.

4. The wireless power transmitter according to claim 1, wherein an average distance between the first transmission coil and the interface surface decreases as a ratio of an area of the first region to a total area of the first transmission coil increases.

5. The wireless power transmitter according to claim 1, wherein a difference between the first distance and the second distance is a thickness of the first transmission coil.

6. The wireless power transmitter according to claim 1, further comprising:
a third transmission coil having a structure symmetrical to the first transmission coil.

7. A wireless power transmitter comprising:
a first transmission coil comprising a first region spaced a first distance from an interface surface and a second region spaced a second distance from the interface surface; and
a second transmission coil overlapping the first region in a horizontal direction,
wherein the first distance is less than the second distance.

8. The wireless power transmitter according to claim 7, wherein the first transmission coil has a shape bent toward the interface surface.

9. The wireless power transmitter according to claim 7, wherein an average distance between the first transmission coil and the interface surface decreases as a ratio of a horizontal length of the first region to a total horizontal length of the first transmission coil increases.

10. The wireless power transmitter according to claim 7, wherein an average distance between the first transmission coil and the interface surface decreases as a ratio of an area of the first region to a total area of the first transmission coil increases.

11. The wireless power transmitter according to claim 7, wherein a difference between the first distance and the second distance is a thickness of the first transmission coil.

12. The wireless power transmitter according to claim 7, further comprising:
a third transmission coil having a structure symmetrical to the first transmission coil.
